(19) United States
(12) Patent Application Publication
(10) Pub. No.: US 2025/0112997 A1
(43) Pub. Date: Apr. 3, 2025

(54) METHOD OF CONTROLLING SERVICE LOAD BY SESSION ON A TELECOMMUNICATIONS CHARGING SYSTEM

(71) Applicant: VIETTEL GROUP, Ha Noi City (VN)

(72) Inventors: TUAN ANH BUI, Hung Ha District (VN); QUANG THANG NGUYEN, Kim Dong District (VN); VAN THO DOAN, Ha Noi City (VN); QUAN HUAN VU, Ha Noi City (VN)

(73) Assignee: VIETTEL GROUP, Ha Noi City (VN)

(21) Appl. No.: 18/899,742

(22) Filed: Sep. 27, 2024

(30) Foreign Application Priority Data
Oct. 3, 2023 (VN) 1-2023-06882

(51) Int. Cl. H04M 15/00; H04W 4/24

(52) U.S. Cl. CPC H04M 15/8027; H04M 15/41; H04W 4/24

(57) ABSTRACT

The method of controlling service load selectively by session in the telecommunications charging system is designed to ensure stable system operation even when the load exceeds the system's capacity. The method consists of three steps: Step 1: the charging system determines the overload status of the system; Step 2: The charging system selectively bypass or accept request according to conditions and has a status memory; Step 3: The charging system analyzes and reprocesses the saved charging requests.

### TECHNICAL FIELDS COVERED

The invention refers to the method to control the load of services selectively by session on the telecommunications charging system. Specifically, the method serves to solve the problem of telecommunications charging to ensure charging system's stability when the load exceeds the charging system's capacity.

### BACKGROUND OF THE INVENTION

The telecommunications charging system communicates with external systems to receive and process two types of requests:
Event-based charging requests: independent charging request sent only once;
Session-based charging requests: multiple charging requests that are linked to each other by a single session identifier.

For session-based charging requests, the telecommunications charging system processes them through the following steps:
Step 1: accept or bypass the incoming charging request based on the current state of the system;
Step 2: process the charging request according to the pre-configured policy;
Step 3: store the session charging information in the database;
Step 4: return charging results to external call centers;

In the process of accepting or bypassing incoming charging messages in step 1, the system must accurately handle the following issues:
How long should the system stay overloaded before it is reasonable to bypass incoming requests?
Should the system bypass all messages or bypass parts of the messages under certain conditions to minimize impact on user services?
When bypassing incoming requests, is there any mechanism to prevent the external system from pushing requests repeatedly, avoiding the domino effect, and keeping the service functioning normally?
When is the system considered not overloaded anymore and able to receive and process new requests normally?
When the system has fully recovered from an overload, is there any mechanism to recalculate the charges for bypassed requests?

The method of controlling the service load selectively by session in the telecommunications charging system mentioned in the invention helps to solve the above problems.

### BRIEF SUMMARY OF THE INVENTION

The method of controlling the load of selective service by session in the telecommunications charging system includes the following steps:
Step 1: The charging system determines the overload status of the system;
The service load, measurement time, upper threshold, lower threshold are used to determine whether the system is overloaded or not.
Step 2: The charging system selectively bypass or accepts requests according to conditions and state of the sessions (bypassed/accepted);
Under normal conditions, charging requests will be accepted and go through the charging process based on the available configuration.

When the system is overloaded, charging requests will be accepted or bypassed based on the unique session identifiers and the state of the session. Specifically:
If a session's charging request is an initialization message, the system will bypass the request as follows:
   Save the session identifier in an in-memory database to mark the bypassing of other messages from the same session.
   Skip the charging process.
   Return a successful error code to external systems so that they stop sending more initialization messages to the charging system.
   Store the charging request in a persistent database for future recalculation of charges.
If the charging request of a session is an update message or a termination message, the system checks whether the temporary storage database has saved the session identifier
   If the temporary in-memory database already contains the session identifier, it means that previous charging messages for this session have been bypassed, so the system continues to bypass this charging message.
   If the temporary in-memory database does not contain the session identifier, the system will decide whether to accept or bypass the message based on its internal load capacity.
Step 3: The charging system performs analysis and reprocessing of saved charging messages;
Upon receiving a request for recalculation from the system, the reprocessing flow for charging messages will read from the persistent database and recalculate charges for the messages that were previously bypassed based on the pre-configured policy.

In this invention, the following definitions are mentioned:
The structure of a charging request includes the following fields:

| | | Description of | |
|---|---|---|---|
| Index | Field Name | information | Data Type |
| 1 | SESSION_ID | Identification of the | Integer |
| | | session, charging requests | |
| | | of the same session have | |
| | | the same identifier. | |
| 2 | REQUEST_TYPE | Charging Request Type | Integer |
| 3 | MSISDN | Subscribers id | String |
| 4 | REQUEST_NUMBER | Charging Message | Integer |
| | | Sequence Number | |
| 5 | REQUEST_TIME | Request Submission | Integer |
| | | Time | |
| 6 | USAGE | Service Usage Volume | Integer |
| 7 | LOCATION | Subscriber's Location | String |
| 8 | SERVICE_TYPE | Subscriber Services Used | Integer |
| 9 | CALL_CENTER | External Call Center | String |
| 10 | . . . | . . . | . . . |

In which:
REQUEST_TYPE in each request takes one of the following values:
   “1”—Initiation request: the message that starts the session. There is only one initiation message per session.
   “2”—Update request: a charging message for the maintenance of the session. Each session can have one or more Update requests.
   “3”—Termination request: the message that signifies the end of the session.

Each session has only one Terminate request.

### BRIEF DESCRIPTION OF THE SEVERAL VIEWS OF THE DRAWINGS

FIG. 1: Depicts the process of determining if the system is experiencing an overload;

FIG. 2: Depicts the process of selectively accepting or bypassing messages based on conditions and state of the session;

FIG. 3: Depicts the process of analysis and reprocessing of saved charging messages.

### DETAILED DESCRIPTION OF THE INVENTION

The method of controlling the load of selective service by session in the telecommunications charging system includes the following steps:
Step 1: The charging system determines the overload status of the system;
The telecommunications charging system defines a set of fixed parameters ascriteria for identifying a system overload. These parameters are stored in a database table called “Overloaded State Determination Criteria” with the following structure:

| STT | Name | Description |
|---|---|---|
| 1 | LOWER_THRESHOLD | Data Type: Integer |
| | | Unit of measurement: number of |
| | | transactions per 1 second |
| | | Meaning: Low Threshold Value for |
| | | Checking Overload StatusUpdate |
| 2 | UPPER_THRESHOLD | Data Type: Integer |
| | | Unit of measurement: number of |
| | | transactions per 1 second |
| | | Meaning: Up Threshold Value for |
| | | Checking Overload StatusUpdate |
| 3 | MAX_TIMES_EXCEEDED_UPPER_ | Data Type: Integer |
| | THRESHOLD | That unit: times |
| | | Meaning: Represents the number of times |
| | | the up threshold value is exceeded. If this |
| | | count is surpassed, it can be considered |
| | | that the system is in an overloaded state |
| 4 | NUMBER_TIMES_EXCEEDED_ | Data Type: Integer |
| | UPPER_THRESHOLD | Unit of measurement: times |
| | | Meaning: Represents the number of |
| | | checks performed for exceeding the high |
| | | threshold. If within these checks, the high |
| | | threshold is exceeded |
| | | MAX_TIMES_EXCEEDED_UPPER_ |
| | | THRESHOLD times, the system is |
| | | considered to be in an overloaded state |
| 5 | NUMBER_TIMES_BELOW_LOWER_ | Data Type: Integer |
| | THRESHOLD | Unit of measurement: times |
| | | Meaning: Represents the number of |
| | | consecutive times the load must be below |
| | | the LOWER_THRESHOLD to stop |
| | | updating the system's overload status. If, |
| | | from the time the system is in an |
| | | overloaded state, the load remains below |
| | | the LOWER_THRESHOLD for |
| | | NUMBER_TIMES_BELOW_LOWER _ |
| | | THRESHOLD consecutive checks, the |
| | | system will stop updating the overload |
| | | status. |
| 6 | CALCULATION INTERVAL | Data Type: Integer |
| | | Unit: millisecond |
| | | Meaning: the time to perform the service |
| | | load calculation, if the configuration is 1 |
| | | second, it is understood to be a load of |
| | | over 1 second, 10 seconds is a load of |
| | | over 10 seconds |

In addition, the telecommunications charging system uses a programming language to store variable parameters in the period CALCULATION INTERVAL as follows:

| STT | Name | Description |
|---|---|---|
| 1 | NUMBER_OF_REQUEST | Data Type: Integer |
| | | Unit of measurement: request number |
| | | Meaning: total number of charging requests |
| | | received from external systems over a period of |
| | | CALCULATION INTERVAL |
| 2 | TPS | Data Type: Integer |
| | | Unit of measurement: request number |
| | | Meaning: Number of Charging Messages per |
| | | Second |
| 3 | STATE | Data Type: An integer value of either 1 or 0 |
| | | Meaning: Represents the system's overload |
| | | status. The STATE value can be one of two |
| | | values: |
| | | STATE = 1: Indicates that the charging system is |
| | | in an overloaded state. |
| | | STATE = 0: Indicates that the charging system is |
| | | in a normal state (not overloaded). |
| 4 | LIST_OF_STATE_COMPARED_ | Data Type: A list of integer elements, where each |
| | UPPER_THRESHOLD | element can have a value of 1 or 0 |
| | | Meaning: The list represents the system's load |
| | | status relative to UPPER_THRESHOLD for |
| | | each second. |
| | | This list has a maximum of |
| | | NUMBER_TIMES_EXCEEDED_UPPER_ |
| | | THRESHOLD elements. |
| | | The i-th element indicates the load status of the |
| | | system relative to UPPER_THRESHOLD at the |
| | | time i seconds before the current moment. |
| | | Each element in the list can have one of two |
| | | values: |
| | | 1: Indicates that the load exceeds the |
| | | UPPER_THRESHOLD threshold. |
| | | 0: Indicates that the load is below the |
| | | UPPER_THRESHOLD threshold. |
| 5 | LIST_OF_STATE_COMPARED_ | Data Type: A list of integer elements, where each |
| | LOWER_THRESHOLD | element can have a value of 1 or 0 |
| | | Meaning: The list represents the system's load |
| | | status relative to LOWER_THRESHOLD for |
| | | each second. |
| | | This list has a maximum of |
| | | NUMBER_TIMES_BELOW_LOWER_ |
| | | THRESHOLD elements. |
| | | The i-th element indicates the load status of the |
| | | system relative to LOWER_THRESHOLD at the |
| | | time i seconds before the current moment. |
| | | Each element in the list can have one of two |
| | | values: |
| | | 1: Indicates that the load exceeds the |
| | | LOWER_THRESHOLD threshold. |
| | | 0: Indicates that the load is below the |
| | | LOWER_THRESHOLD threshold. |

The process of determining the overload status of the system using a set of fixed parameters and variable parameters is described in detail in two steps as follows:
Step 1.1: The charging system calculates the variable parameters in each CALCULATION INTERVAL period
Each time a charging request is received from external systems, the NUMBER_OF_REQUEST is increased by one unit
After each CALCULATION INTERVAL period:
+ The system recalculates the load of the service at the current time through the formula:

$$TPS = \frac{NUMBER\_OF \_REQUEST * 1000}{CALCULATION INTERVAL}$$

+ Update the number of charging requests: NUMBER_OF_REQUEST=0
+Update LIST_OF_STATE_COMPARED_UPPER_THRESHOLD list: Compare TPS with UPPER_THRESHOLD value.
   If TPS<=UPPER_THRESHOLD: update LIST_OF_STATE_COMPARED_UPPER_THRESHOLD (i)=LIST_OF_STATE_COMPARED_UPPER_THRESHOLD (i-1) with i>0; LIST_OF_STATE_COMPARED_UPPER_THRESHOLD (0)=1
   If TPS<UPPER_THRESHOLD: update LIST_OF_STATE_COMPARED_UPPER_THRESHOLD (i)=LIST_OF_STATE_COMPARED_UPPER_THRESHOLD (i-1) with i>0; LIST_OF_STATE_COMPARED_UPPER_THRESHOLD (0)=0
+ Update LIST_OF_STATE_COMPARED_LOWER_THRESHOLD list: Compare TPS with LOWER_THRESHOLD value.
   If TPS>=LOWER_THRESHOLD: update LIST_OF_STATE_COMPARED_LOWER_THRESHOLD (i)=LIST_OF_STATE_COMPARED_LOWER_THRESHOLD (i-1) with i>0; LIST_OF_STATE_COMPARED_LOWER_THRESHOLD (0)=1
   If TPS<LOWER_THRESHOLD: update LIST_OF_STATE_COMPARED_LOWER_THRESHOLD (i)=LIST_OF_STATE_COMPARED_LOWER_THRESHOLD (i-1) with i>0; LIST_OF_STATE_COMPARED_LOWER_THRESHOLD (0)=0

The end of step 1.1 obtains the values of the variable parameters at a time, which are the input for the next processing steps.
Step 1.2: update the overload status of the system:
Determine the overload statusof the system by the following quantitative function:

$$f ( StatePrevious , {ListOfState}_{i} , {Threshold}_{i} ) = StatePrevious ⋆ = * {\prod }_{i = 1}^{n} {Rule}_{i}$$

The f function takes these input parameters:
+ StatePrevious: accepts either the value of 0 or 1;
+ ListOfStateᵢ: the list of elements that accept either a value of 0 or 1;
+ Thresholdᵢ: accepts integer values;

In which:

Ruleᵢ: compare the values of the elements in ListOfStateᵢ with 1.
If ListOfStateᵢ has at least n elements greater than or equal to 1, then Ruleᵢ returns the result 1;
On the contrary, Ruleᵢ returns 0;

The function f returns the result as the product of StatePrevious and the Ruleᵢ. This product takes either a value of 0 or 1. From the result of the f function, update the state of the system accordingly via parameter STATE.
The first example: the function f takes five input parameters (the values of the five variable parameters at each measurement time):
   + StatePrevious=STATE=1
   + ListOfState₁=LIST_OF_STATE_COMPARED_UPPER_THRESHOLD=[1,0,1,1,0]
   + Threshold₁=NUMBER_TIMES_EXCEEDED_UPPER_THRESHOLD=3
   + ListOfState₂=LIST_OF_STATE_COMPARED_LOWER_THRESHOLD=[1,1,0]
   + Threshold₂=1

Subsequently, further rules are applied as follows:
+ Rule₁: compare the elements in the list ListOfState₁ to 1; since there are three values in ListOfState₁ that are equal 1 (i.e. in the last three overload times the overload threshold has been exceeded), a value of 1 should be returned.
+ Rule₂: compare the elements in the list ListOfState₂ with 1; because there are two values in ListOfState₂ that greater than or equal 1 (i.e. in ListOfState₂>=1 load exceeding the overload threshold), the value of 1 should be returned.
+ The result of function f is 1.

Second example: suppose the charging system uses a set of parameters:

| Index | Name | Value |
|---|---|---|
| 1 | LOWER_THRESHOLD | 4000 |
| 2 | UPPER_THRESHOLD | 5000 |
| 3 | MAX_TIMES_EXCEEDED_UPPER_ | 3 |
| | THRESHOLD | |
| 4 | NUMBER_TIMES_EXCEEDED_ | 5 |
| | UPPER_THRESHOLD | |
| 5 | NUMBER_TIMES_BELOW_LOWER_ | 10 |
| | THRESHOLD | |
| 6 | CALCULATION INTERVAL | 1000 |

The charging system's TPS for the period from 15:02:00 to 15:02:19 is calculated as follows

| Index | Timing | TPS |
|---|---|---|
| 1 | 15:02:00 | 5100 |
| 2 | 15:02:01 | 4950 |
| 3 | 15:02:02 | 4900 |
| 4 | 15:02:03 | 5150 |
| 5 | 15:02:04 | 5200 |
| 6 | 15:02:05 | 4880 |
| 7 | 15:02:06 | 4600 |
| 8 | 15:02:07 | 4550 |
| 9 | 15:02:08 | 4200 |
| 10 | 15:02:09 | 4100 |
| 11 | 15:02:10 | 3900 |
| 12 | 15:02:11 | 3850 |
| 13 | 15:02:12 | 3900 |
| 14 | 15:02:13 | 3150 |
| 15 | 15:02:14 | 3200 |
| 16 | 15:02:15 | 3880 |
| 17 | 15:02:16 | 3600 |
| 18 | 15:02:17 | 3550 |
| 19 | 15:02:18 | 3200 |
| 20 | 15:02:19 | 3100 |

From 15:02:00 to 15:02:04, there are three instances out of five when TPS exceeded the threshold of 5000. Therefore, at 15:02:04, the charging system will update the overload status to STATE=1.

From 15:02:10 to 15:02:19 there are ten consecutive instances where TPS is below the threshold of 4000. Therefore, at 15:02:19, the charging system will update the status back to normal, STATE=0.

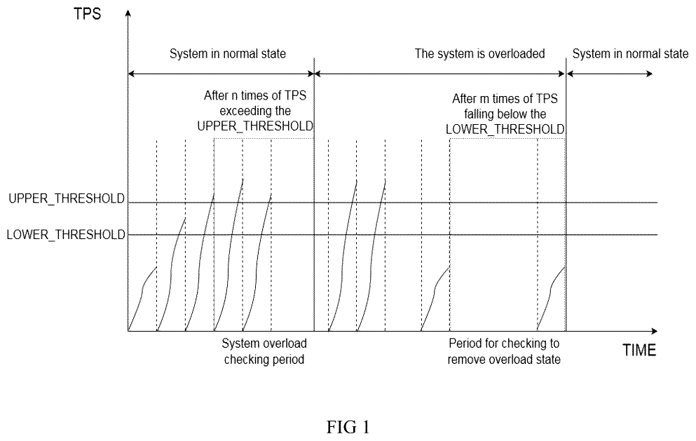

At the end of step 1.2 specifically and step 1 in general, we can determine whether the charging system is in a normal or overloaded state at the measurement time. (Refer to FIG. 1).
Step 2: The charging system selectively bypass or accepts requests according to conditions and state of the session;
The charging system uses the following storage technologies:
In-memory temporary database: the database is stored on the main memory (RAM), which speeds up data updates and queries. At this stage, the system used to store the identifier key of each charging session has been bypassed.
Persistent database: the database is stored on the hard drive, avoiding the risk of data loss. At this stage, the charging system is used to save the charging requests that have been rejeted, for the purpose of analysing and processing the charge recalculation.

The previous step mentioned the input load parameters from core network systems and the mechanism for checking input overload. However, the charging system consists of many applications, each with its own load capacity. Therefore, sensible overload protection must take into account both internal load and input load from external systems.

The charging system defines through a programming language variable parameters in the following CALCULATION INTERVAL period:

| STT | Name | Describe |
|---|---|---|
| 1 | NUMBER_ | Value: integer type |
| | OF_ | Unit: request number |
| | RESPONSE | Meaning: The total number of requests that |
| | | have been processed and responded to the |
| | | external system within a period of |
| | | CALCULATION INTERVAL |
| 2 | LOCAL_TPS | Value: integer type |
| | | Unit: request number |
| | | Meaning: The total number of requests that |
| | | have been processed and responded to the |
| | | external system within a period of one second |
| | | The formula for calculating the internal load |
| | | is as follows: |
| | | $LOCAL\_TPS = \frac{NUMBER\_OF \_RESPONSE * 1000}{CALCULATION INTERVAL}$ |

Based on the above variable parameters, the process of bypassing or accepting a charging request is described in detail in the following steps:
Step 2.1: check the overload status of the system (updated through step 1);
If the system is normal (i.e. not overloaded, STATE=0), the charging request will be forwarded to the internal applications in the charging system to calculate based on the pre-configured policies;
If the system is overloaded (STATE=1), perform step 2.2.
Step 2.2: Check the information of the charging request;
Check the REQUEST_TYPE of the charging request:
If it's an Initialization Request (REQUEST_TYPE=1): This is the initialization message for a new session, so move to step 2.3 to always bypass.
If it's not an Initialization Request (REQUEST_TYPE other than the value 1), move to step 2.6 to check the previously bypassed status.
Step 2.3: store SESSION_ID in the temporary in-memory database;
Store the SESSION_ID (the identifier of the charging session) in the temporary in-memory database and move to step 2.4;
Step 2.4: Store the charging request in the persistent database so that the independent charging application can reprocess the bypassed message. The storage structure of the request is as follows:

| | | Description of | |
|---|---|---|---|
| Index | Field Name | information | Data Type |
| 1 | SESSION_ID | Identification of the | Integer |
| | | session, charging requests | |
| | | of the same session have | |
| | | the same identifier. | |
| 2 | REQUEST_TYPE | Charging request Type | Integer |
| 3 | MSISDN | Subscribers id | String |
| 4 | REQUEST_NUMBER | Charging Message | Integer |
| | | Sequence Number | |
| 5 | REQUEST_TIME | Request Submission | Integer |
| | | Time | |
| 6 | USAGE | Service Usage Volume | Integer |
| 7 | LOCATION | Subscriber's Location | String |
| 8 | SERVICE_TYPE | Subscriber services used | Integer |
| 9 | CALL_CENTER | External call center | String |
| 10 | . . . | . . . | . . . |

After storing, move to step 2.5.
Step 2.5: Create a response message with a success error code that has been agreed on with the core network systems. Finish processing the charging request.
Step 2.6: check the status of previous bypassed sessions:
Check if the SESSION_ID of the charging request is already in the temporary in-memory database:
If yes, this charging session has been previously bypassed, move back to step 2.4 to continue bypassing it;
If no: the charging session has not been previously bypassed, move to step 2.7 to check the internal load of the charging system;
Step 2.7: check the internal load of the charging system;
If LOCAL_TPS<LOWER_THRESHOLD: the internal applications of the charging system have not reached the overload threshold, so the charging request will be forwarded to these applications for normal charging processing.
If LOCAL_TPS>=LOWER_THRESHOLD: the internal applications of the charging system have exceeded the overload threshold, move the message to step 2.8 to continue checking the REQUEST_TYPE of the message, and simultaneously bypass processing the message.
Step 2.8: check the information of the charging request;
Check the REQUEST_TYPE of the charging request:
If it is an Update message (feature key REQUEST_TYPE=2): this will be the first update request to bypass, so move to step 2.3 to store the feature key and bypass.
If it is a Termination message (feature key REQUEST_TYPE=3): since it is the final message of a charging session, there is no need to store the feature key, so move to step 2.4 to bypass.

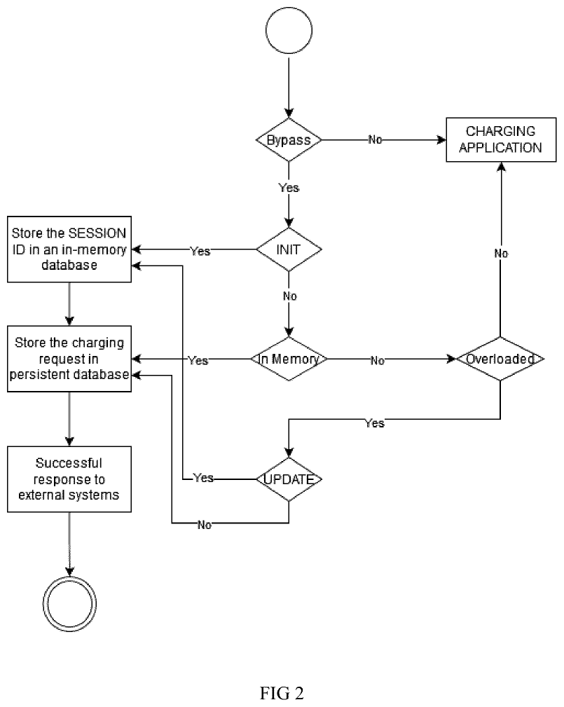

At the end of step 2, we have established which charging messages are processed and which are bypassed. The charging system stores the bypassed charging messages for reprocessing in step 3. (Refer to FIG. 2).
Step 3: The charging system performs analysis and reprocessing of saved charging messages;
The charging system designed the processing flow for charging requests that have been bypassed (no charging processing) in step 2. Details of the handling steps are as follows:
Step 3.1: Automatically determine whether the reprocessing flow is active;
At each CALCULATION INTERVAL period.
Determine the automatic status of the processing flow through the following quantitative function:

$$f ( {Tps}_{i} , {MaxThreshold}_{i} , {PercentageThreshold}_{i} ) = {\prod }_{i = 1}^{n} {Rule}_{i}$$

The f function takes the input parameters:
+ Tpsᵢ: List of elements that are integers
+ MaxThresholdᵢ: accepts integer values
+ PercentageThresholdᵢ: accepts an integer between 0 and 100

In which:
Ruleᵢ: compare the values Tpsᵢ with

$${MaxThreshold}_{i} * \frac{{PecrentageThreshold}_{i}}{100}$$

If there is

$${Tps}_{i} > {MaxThreshold}_{i} * \frac{{PercentageThreshold}_{i}}{100} ,$$

return result 1

Otherwise, Ruleᵢ returns 0 results

The function f returns the result as the product of Ruleᵢ. This product takes either a value of 0 or 1. From the result of function f:
+ If f=1: The system does not need to automatically reprocess the charging; continue to check step 3.1 after the CALCULATION INTERVAL interval.
+ If f=0: The system automatically activates the re-charging flow for the messagesstored in the persistent database. Move to step 3.2.
The third example: function f takes six input parameters, the parameters are calculated in step 1 and step 2 with the following values:

$${Tps}_{1} = TPS = 1000$$

$${MaxThreshold}_{1} *= UPPER\_THRESHOLD = 1200$$

$${Percentage Threshold}_{1} = 80$$

$${Tps}_{2} = LOCAL\_TPS = 680$$

$${MaxThreshold}_{2} = UPPER\_THRESHOLD = 1200$$

$${PercentageThreshold}_{2} = 70$$

Subsequently, further rules are applied as follows:
Rule₁: compare Tps₁ with

$${MaxThreshold}_{1} * \frac{80}{100} ,$$

the result returns 1.
Rule₂: compare Tps₂ to

$${MaxThreshold}_{2} * \frac{70}{100} ,$$

the result returns 0.
The result of the function f returns 0.
Step 3.2: Process the charging requests; This step is done through the following substeps:
Step 3.2.1: retrieve a charging request from the persistent database;
Step 3.2.2: check the information of the charging request and transfer it to the normal charging processing flow.

Check the REQUEST_TYPE attribute of the message:
If it is an Initiation message (attribute REQUEST_TYPE=1): send the Initiation charging request to the charging application to process the charging according to the pre-configured policy
If it is an Update message (attribute REQUEST_TYPE=2): send the Update charging request to the charging application to process the charging according to the pre-configured policy
If it is a Termination message (attribute REQUEST_TYPE=3): send the Terminate charging request to the charging application to process the charging according to the pre-configured policy.
Step 3.2.3: wait for a response from the charging application. After receiving the response message, return to step 3.1 to continue determining the status of the re-charging flow.

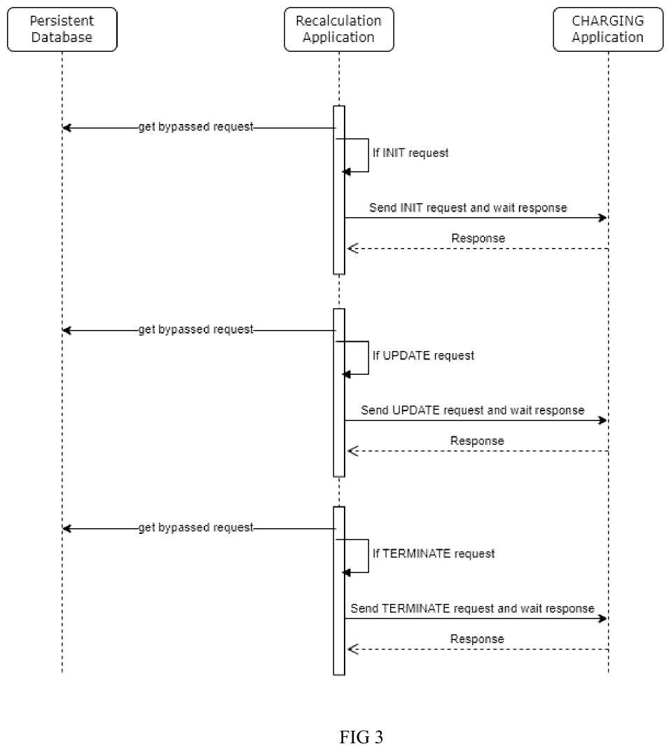

At the end of step 3, the charging system has evaluated the internal overload status. If the system is confirmed to be in the normal state, the system reprocesses the charging request that have been saved. (Refer to FIG. 3).

1. A method of controlling service load by session on a telecommunications charging system includes the following steps:
Step 1: The charging system determines if the system is experiencing an overload; this step is done through the following substeps:
Step 1.1: The charging system calculates parameters in each CALCULATION INTERVAL period
Each time a charging request is received from an external systems, a NUMBER_OF_REQUEST is increased by one unit
After each CALCULATION INTERVAL period:
+ The charging system recalculates a load of the service at a current time through the formula:
$$TPS = \frac{NUMBER\_OF \_REQUEST * 1000}{CALCULATION INTERVAL}$$
+ Update a number of charging requests: NUMBER_OF_REQUEST=0
+ Update LIST_OF_STATE_COMPARED_UPPER_THRESHOLD list: Compare TPS with UPPER_THRESHOLD value;
If TPS>=UPPER_THRESHOLD: update LIST_OF_STATE_COMPARED_UPPER_THRESHOLD (i)=LIST_OF_STATE_COMPARED_UPPER_THRESHOLD (i-1) with i>0; LIST_OF_STATE_COMPARED_UPPER_THRESHOLD (0)=1
If TPS<UPPER_THRESHOLD: update LIST_OF_STATE_COMPARED_UPPER_THRESHOLD (i)=LIST_OF_STATE_COMPARED_UPPER_THRESHOLD (i-1) with i>0; LIST_OF_STATE_COMPARED_UPPER_THRESHOLD (0)=0
+ Update LIST_OF_STATE_COMPARED_LOWER_THRESHOLD list: Compare TPS with LOWER_THRESHOLD value;
If TPS>=LOWER_THRESHOLD: update LIST_OF_STATE_COMPARED_LOWER_THRESHOLD (i)=LIST_OF_STATE_COMPARED_LOWER_THRESHOLD (i-1) with i>0; LIST_OF_STATE_COMPARED_LOWER_THRESHOLD (0)=1
If TPS<LOWER_THRESHOLD: update LIST_OF_STATE_COMPARED_LOWER_THRESHOLD (i)=LIST_OF_STATE_COMPARED_LOWER_THRESHOLD (i-1) with i>0; LIST_OF_STATE_COMPARED_LOWER_THRESHOLD (0)=0
the end of step 1.1 obtains values of variable parameters at a time, which are input for the next processing steps;
Step 1.2: update a overload of the charging system:
determine the overload status of the chargin system by the following quantitative function:
$$f ( StatePrevious , {ListOfState}_{i} , {Threshold}_{i} ) = StatePrevious * {\prod }_{i = 1}^{n} {Rule}_{i}$$
the f function takes input parameters:
+ StatePrevious: accepts either the value of 0 or 1;
+ ListOfStateᵢ: a list of elements that accept either a value of 0 or 1;
+ Thresholdᵢ: accepts integer values;
in which:
Ruleᵢ: compare values of the elements in ListOfStateᵢ with 1;
if ListOfStateᵢ has at least n elements greater than or equal to 1, then Ruleᵢ returns the result 1;
on the contrary, Ruleᵢ returns 0;
the function f returns a result as the product of StatePrevious and the Ruleᵢ; this product takes either a value of 0 or 1, from the result of the f function, update the state of the charging system accordingly via parameter STATE;
at the end of step 1.2 specifically and step 1 in general, we can determine whether the charging system is in a normal or an overloaded state at a measurement time;
Step 2: the charging system selectively bypasses or accepts requests according to conditions and state of the sessions;
the charging system defines through a programming language variable parameters in the following CALCULATION INTERVAL period:

| STT | Name | Describe |
|---|---|---|
| 1 | NUMBER_ | Value: integer type |
| | OF_ | Unit: request number |
| | RESPONSE | Meaning: The total number of requests that |
| | | have been processed and responded to the |
| | | external system within a period of |
| | | CALCULATION INTERVAL |
| 2 | LOCAL_TPS | Value: integer type |
| | | Unit: request number |
| | | Meaning: The total number of requests that |
| | | have been processed and responded to the |
| | | external system within a period of one second |
| | | The formula for calculating the internal load |
| | | is as follows: |
| | | $LOCAL\_TPS = \frac{NUMBER\_OF \_RESPONSE * 1000}{CALCULATION INTERVAL}$ |

based on the above variable parameters, the process of bypassing or accepting a charging request comprises the following steps:
Step 2.1: check the overload status of the charging system (updated through step 1);
if the system is normal (i.e. not overloaded, STATE=0), the charging request is forwarded to internal applications in the charging system to calculate based on the pre-configured policies;
if the system is overloaded (STATE=1), perform step 2.2;
Step 2.2: check the information of the charging request;
check the REQUEST_TYPE of the charging request:
if the REQUEST_TYPE of the charging request is an Initialization Request (REQUEST_TYPE=1): this is the initialization message for a new session, so move to step 2.3 to always bypass;
If if the REQUEST_TYPE of the charging request is not an Initialization Request (REQUEST_TYPE other than the value 1), move to step 2.6 to check the previously bypassed status of the session;
Step 2.3: store SESSION_ID in a temporary in-memory database;
store the SESSION_ID (the identifier of the charging session) in the temporary in-memory database and move to step 2.4;
Step 2.4: store the charging request in a persistent database so that an independent charging application can reprocess the bypassed message the storage structure of the request is as follows:

| | | Description of | |
|---|---|---|---|
| Index | Field Name | information | Data Type |
| 1 | SESSION_ID | Identification of the | Integer |
| | | session, charging requests | |
| | | of the same session have | |
| | | the same identifier | |
| 2 | REQUEST_TYPE | Charging Request Type | Integer |
| 3 | MSISDN | Subscribers Id | String |
| 4 | REQUEST_NUMBER | Charging Message | Integer |
| | | Sequence Number | |
| 5 | REQUEST_TIME | Request Submission | Integer |
| | | Time | |
| 6 | USAGE | Service Usage Volume | Integer |
| 7 | LOCATION | Subscriber's Location | String |
| 8 | SERVICE_TYPE | Subscriber Services Used | Integer |
| 9 | CALL_CENTER | External Call Center | String |
| 10 | . . . | . . . | . . . |

after storing, move to step 2.5;
Step 2.5: create a response message with a success error code that has been agreed on with a core network systems, finish processing the charging request;
Step 2.6: check the status of previous bypassed sessions:
check if the SESSION_ID of the charging request is already in the temporary in-memory database:
if yes, this charging session has been previously bypassed, move back to step 2.4 to continue bypassing it;
if no: the charging session has not been previously bypassed, move to step 2.7 to check the internal load of the charging system;
Step 2.7: check the internal load of the charging system;
i LOCAL_TPS<LOWER_THRESHOLD: the internal applications of the charging system have not reached the overload threshold, so the charging request will be forwarded to these applications for normal charging processing;
if LOCAL_TPS>LOWER_THRESHOLD: the internal applications of the charging system have exceeded the overload threshold, move the message to step 2.8 to continue checking the REQUEST_TYPE of the message, and simultaneously bypass processing the message;
Step 2.8: check the information of the charging request;
check the REQUEST_TYPE of the charging request:
if the information of the charging request is an Update message (feature key REQUEST_TYPE=2): this will be a first update request to bypass, so move to step 2.3 to store the feature key and bypass;
if the information of the charging request is a Termination message (feature key REQUEST_TYPE=3): since it is a final message of a charging session, there is no need to store the feature key, so move to step 2.4 to bypass;
at the end of step 2, we have established which charging messages are processed and which are bypassed, the charging system stores the bypassed charging messages for reprocessing in step 3;
Step 3: the charging system performs analysis and reprocessing of saved charging messages;
the charging system designed the processing flow for charging requests that have been bypassed (no charging processing) in step 2 as follows:
Step 3.1: automatically determine whether a reprocessing flow is active;
at each CALCULATION INTERVAL period,
determine an automatic status of the processing flow through the following quantitative function:
$$f ( {Tps}_{i} , {MaxThreshold}_{i} , {PercentageThreshold}_{i} ) = {\prod }_{i = 1}^{n} {Rule}_{i}$$
the f function takes the input parameters:
+ Tpsᵢ: List of elements that are integers
+ MaxThresholdᵢ: accepts integer values
+ PercentageThresholdᵢ: accepts an integer between 0 and 100
in which:
Ruleᵢ: compare the values Tpsᵢ with
$${MaxThreshold}_{i} * \frac{{PercentageThreshold}_{i}}{100}$$
If there is
$${Tps}_{i} > {MaxThreshold}_{i} * \frac{{PercentageThreshold}_{i}}{100} ,$$
return result 1
Otherwise, Ruleᵢ returns 0 results
the function f returns the result as the product of Rule;, this product takes either a value of 0 or 1, from the result of function f:
+ if f=1: the charging system does not need to automatically reprocess the charging; continue to check step 3.1 after the CALCULATION INTERVAL interval;
+ if f=0: The charging system automatically activates the re-charging flow for the messages stored in the persistent database, move to step 3.2;
Step 3.2: processing the charging requests; this step is done through the following substeps:
Step 3.2.1: retrieve a charging request from the persistent database;
Step 3.2.2: check the information of the charging request and transfer it to the normal charging processing flow;
check the REQUEST_TYPE attribute of the message:
if it is an Initiation message (attribute REQUEST_TYPE=1): send the Initiation charging request to the charging application to process the charging according to the pre-configured policy
if it is an Update message (attribute REQUEST_TYPE=2): send the Update charging request to the charging application to process the charging according to the pre-configured policy
if it is a Termination message (attribute REQUEST_TYPE=3): send the Terminate charging request to the charging application to process the charging according to the pre-configured policy;
Step 3.2.3: wait for a response from the charging application, after receiving the response message, return to step 3.1 to continue determining the status of the re-charging flow;
at the end of step 3, the charging system has evaluated the internal overload status, if the system is confirmed to be in the normal state, the system reprocesses the charging requests that have been saved in the persistent database.
